(19) United States
(12) Patent Application Publication
(10) Pub. No.: US 2012/0164038 A1
(43) Pub. Date: Jun. 28, 2012

(54) Lidded Container

(75) Inventors: Juergen LOEHN, Hamburg (DE); Martin SEIPPEL, Ammersbek (DE)

(73) Assignee: EPPENDORF AG, Hamburg (DE)

(21) Appl. No.: 13/326,102

(22) Filed: Dec. 14, 2011

Related U.S. Application Data
(60) Provisional application No. 61/427,730, filed on Dec. 28, 2010.

(30) Foreign Application Priority Data
Dec. 23, 2010 (DE) 10 2010 055 776.5

(51) Int. Cl. B01L 3/00

(52) U.S. Cl. 422/551

(57) ABSTRACT

A lidded container comprising

a tubular container which at the bottom has a container base, at the top a container opening and below the container opening a sealing region on the internal wall,

a lid which has a lid base and a plug protruding from the inside of the lid base, insertable through the container opening into a sealed position in the sealing region,

a strap hinge connecting the container parts, lid and container, integrally together in a pivotable manner and

a holding device having at least two engagement means, one being an axial engagement means fixedly connected to the container or lid, the other engagement means being configured on the longitudinal side of the strap hinge and the engagement means being able to be brought into engagement by pivoting the lid into the holding position, which is accompanied by a resilient compensation movement.

### CROSS-REFERENCE TO RELATED APPLICATIONS

Conversion from U.S. Provisional Patent Application No. 61/427,730*.

### STATEMENT REGARDING FEDERALLY SPONSORED RESEARCH

Not applicable.

### BACKGROUND OF THE INVENTION

The invention relates to a lidded container made of plastics material for laboratory use.

Lidded containers of the aforementioned type typically have a capacity of a few tenths of a milliliter or several milliliters or one milliliter or less.

Known lidded containers made of plastics material for laboratory use comprise a tubular container which at the bottom has a container base, at the top a container opening and below the container opening a sealing region on the internal wall. A lid which comprises a lid base and a plug protruding from the inside of the lid base is able to be inserted through the container opening into a sealed position in the sealing region. The lid is sealed and held by the clamping force of the plug in the container. Applications exist in which a sample liquid filled into the container is heated and has an increased vapor pressure. For example, in polymerase chain reaction (PCR) technology, samples are repeatedly heated in the lidded containers, for example to temperatures of over 90° C. The level of the clamping force of the plug has to be such that sufficient vapor tightness is ensured and the lid is not released by the increased vapor pressure. As a result, it is necessary to expend a high degree of force in order to force the lid with the plug into the container. In order to open the lid the user has to press firmly against the lower edge of a protruding edge of the lid base. A lidded container of the aforementioned type is disclosed in EP 0 841 093 A2, the entire contents of which is incorporated herein by reference, and U.S. Pat. No. 5,863,791, the entire contents of which is incorporated herein by reference, in which the container and lid are integrally connected together in a pivotable manner via a strap hinge. The lid has a locking hook protruding downwards from a lid flange protruding to the side, and the container adjacent to the container opening has a locking cam behind which the locking hook is engaged in the closed position. When the lid is closed, the rigid locking hook snaps behind the locking cam by the resilient deformation of the lid flange, whereby the lid is secured in the closed position. To open the lid, the user has to force up the lid flange so that said lid flange is bent upwards and the locking hook is released from the locking cam. To this end, the locking hook and the locking cam only have a small overlap. Due to the small overlap, the locking hook may be inadvertently released from the locking cam, for example when the internal pressure rises in the container. When the lid is opened, the locking hook is able to be released abruptly from the locking cam, and as a result of which liquid samples may spray out of the container.

The lidded container has a support device which stabilizes the lid on the container opening in an intermediate position between an initial position pivoted away from the container opening by approximately 180° and a closed position.

In one embodiment of the lidded container, between the hinge straps two parallel fork tines extend from the container flange, between which a gap parallel to the hinge straps is formed. The fork tines have latching edges. A latching lug is oriented with the gap and is connected at its tip to the lid flange and at its base has latching projections on both sides. The latching lug is oriented with its latching projections perpendicular to the lid flange. If the lid is folded down in the direction of the container opening, the latching lug enters the gap between the fork tines and forces said fork tines with their latching projections slightly apart. When the latching projections pass under the latching edges of the fork tines, said fork tines snap together slightly. If the lid is then released, the latching projections are held back by the latching edges and the lid is stabilized in the pivoted position which has been reached. It is a drawback here that during injection-molding the delicate fork tines form flow path ends which are difficult to ventilate due to their size. Air bubbles at the end of the flow path may lead to the formation of incomplete fork tines. The formation of complete fork tines is, however, necessary for the above-described pivoted position.

In a further embodiment, the support device comprises a latching lug which is formed as a hook protruding upwards from the plane of the container flange. The latching lug is arranged between flexible central portions of two parallel hinge straps, which are connected at one end to the container flange and at the other end to the lid flange. The lid flange has a latching edge between the hinge straps oriented perpendicular to the pivoting plane thereof A flexibility of the latching lug and/or the hinge straps permits the latching edge to be raised over the end of the latching lug, when folding down the lid. If the lid is then released, as a result of the resilience of the central portions it is pressed with the latching edge against the latching lug, so that it remains in this stable pivoted position in which the container is opened. To close the container, the lid is pivoted shut again and snapped with the locking hook behind the locking cam. It is a drawback here that the intermediate position may be difficult to reach due to the flexibility of the hinge straps. If, when pivoting the lid shut, the user presses from above against the outer edge of the lid flange, the user displaces the lid downwards due to the flexibility of the hinge straps. As a result, the latching edge comes into contact with the latching lug at a low point and is only able to be pressed over the end of the latching lug by expending a high degree of force.

It is a drawback in both embodiments that the stability of the open position of the lid depends on the resilience of the strap portions. If the resilience is reduced, for example due to repeated closing and opening of the lid or by heating and/or cooling the container, the lid may move inadvertently out of the predetermined intermediate position and entirely or partially close the container opening. This may impair the filling and emptying of the lidded container.

In a further embodiment, two parallel hinge straps are also arranged between the container flange and the lid flange, the flexibility of said hinge straps being substantially concentrated on the narrowly defined region of a pivot axis. The container flange and the lid flange are connected by a further hinge strap, which is arranged between the hinge straps. The further hinge strap has at one end a joint with the container flange and at the other end a joint with the lid flange. Between said two joints the hinge strap is of relatively thin configuration, so that it is may be stretched in a resilient manner. After injection-molding the lidded container, the lid is bent back by approximately 180° from the container opening. In this initial position, the further hinge strap is not stretched. If the lid is now folded down around the pivot axis, the distance between the joints increases and the further hinge strap is slightly resiliently stretched until it is arranged on the pivot axis, about which the lid may be pivoted relative to the container. If the lid is then pivoted shut, the further hinge strap slightly contracts again, until it reaches its initial length. This is the case with an alignment of the lid of approximately 90° relative to the container opening. In this stable pivoted position, the lid is stabilized relative to the container by the further hinge strap. If the lid is folded down further, the further hinge strap is bent outwards. When the lid is closed, the latching hook in cooperation with the latching cam prevents the lid from opening. After unlocking, the lid is again able to move back into its stable pivoted position or into the initial position.

It is a drawback with this lidded container that, due to the narrowly defined region of the pivot axis, the hinge straps do not permit any compensation movement when introducing the inventive sealing collar into the container opening. As a result, it is more difficult to close the lid. In the exemplary embodiments with flexible central portions of the hinge straps, however, the flexible central portions permit a compensation movement which simplifies the coaxial introduction of the sealing collar into the container.

U.S. Pat. No. 5,358,130, the entire contents of which is incorporated herein by reference, discloses a one-piece container closure with devices for holding the lid open during dispensing. The closure comprises a cap with means for connecting to the container and a lid. The lid is connected to a supporting arm which is connected via a joint to the cap. When the lid is closed, the supporting arm extends between two projections which protrude upwards from the cap. Elongate ribs protruding to the side of the supporting arm are dimensioned so that they come into engagement with the projections and hold the lid in an open position when the container is tilted. If the lid is moved into the closed position, the ribs are deformed so that they pass between the projections. The projections have receivers which receive the ribs without contact when the lid is in the closed position.

In this container closure, the clamping which holds the lid in the open position may be insufficient and/or may be reduced after use with repeated opening and closing and/or heating and/or cooling, so that the lid is no longer securely held open.

In the lidded containers according to EP 1 731 443 A1, the entire contents of which is incorporated herein by reference, U.S. Pat. No. 3,934,722, the entire contents of which is incorporated herein by reference, U.S. Pat. No. 5,270,011, the entire contents of which is incorporated herein by reference, U.S. Pat. No. 5,674,456, the entire contents of which is incorporated herein by reference, U.S. Pat. No. 6,398,067 B1, the entire contents of which is incorporated herein by reference, and WO 95/13137 A1, the entire contents of which is incorporated herein by reference, the lid is integrally connected to the container via a hinge strap. Said lidded containers do not have a supporting device for holding the lid in a defined pivoted position.

Proceeding therefrom, an object of the invention is to provide a lidded container made of plastics material for laboratory use, which is able to hold the lid securely in at least one position, in which the lid does not close the container.

### BRIEF SUMMARY OF THE INVENTION

The lidded container according to the invention made of plastics material for laboratory use comprises

a tubular container which at the bottom has a container base, at the top a container opening and below the container opening a sealing region on the internal wall,

a lid which has a lid base and a plug protruding from the inside of the lid base, and which may be inserted through the container opening into a sealed position in the sealing region,

a strap hinge connecting the two container parts, lid and container, integrally together in a pivotable manner and

a holding device for holding the lid in at least one holding position in which the lid is not inserted into the sealed position, the holding device having at least two engagement means, the one engagement means being an axial engagement means fixedly connected to the container or lid, and which is oriented perpendicular to the pivoting plane defined by the pivoting path of the lid, the other engagement means being configured on the longitudinal side of the strap hinge and the engagement means being able to be brought into engagement with one another by pivoting the lid into the holding position, which is accompanied by a resilient compensation movement.

In the lidded container according to the invention, the container and lid are pivotably connected together via a strap hinge in the known manner. The strap hinge may comprise one or more hinge straps, which are at least partially flexible. The strap hinge is similar to a film hinge but may be flexible over a longer region in its longitudinal direction. A strap hinge with at least one hinge strap which is flexible in at least one region in the longitudinal direction simplifies the insertion of the plug in the container opening of a cylindrical container as it permits a compensation movement.

Furthermore, the lidded container comprises a holding device which is able to hold the lid relative to the container in at least one holding position in which the lid does not close the container. In the holding position, the lid is not inserted with the plug into the sealed position in the sealing region. For holding the lid in the holding position, the container or the lid is connected to an axial engagement means. The axial engagement means is oriented perpendicular to the pivoting plane defined by the pivoting path of the lid. The other engagement means is formed on the longitudinal side on the strap hinge. If, when pivoting the lid, the axial engagement means and the engagement means formed on the longitudinal side of the strap hinge come into contact with one another, a resilient deviation movement permits said engagement means to be moved past one another and come into engagement in the holding position. The resilient deviation movement may consist, for example, of a resilient deformation of the axial engagement means and/or a lateral deviation of the strap hinge. The pivoting of the lid into the holding position takes place independently of the pivoting path which the lid performs. The pivoting path of the lid is variable as it is connected to the container via a flexible strap hinge, in order to simplify the insertion of the plug in the container, and not via a joint with a precisely defined pivot axis. The pivoting path of the lid is determined, in particular, by the level, the direction and the point of action of the force with which the user presses against the lid. In the lidded container according to the invention, this is not affected by considerably increasing the force in order to reach the holding position.

It is additionally advantageous that an axial engagement means is formed on the strap hinge so that material may be saved. The lid is held in the holding position by the resilience of the strap hinge. If the lid is pivoted into the holding position, the strap hinge is resiliently deformed. Thus the resilience of the strap hinge holds the engagement means in the holding position in engagement with one another and prevents the lid from being inadvertently pivoted closed again.

The lidded container according to the invention is particularly advantageous in terms of injection-molding technology, as functional areas of the engagement means coming into engagement with one another are not flow path ends which would be the last to be filled with plasticized plastics material when filling the mould, so that air could collect therein which is only able to be removed with difficulty by ventilating the mould. As a result, the functional areas which are important for maintaining the holding position may be produced particularly easily and accurately by injection-molding.

According to one embodiment, a support comprising at least one axial engagement means arranged thereon protrudes to the side from the one container part, and at least one axial engagement means which may be brought into engagement therewith is formed on a longitudinal side of the strap hinge adjacent to the support.

According to a further embodiment, the support is disc-shaped with side surfaces extending parallel to the pivoting plane of the lid and on both side surfaces comprises axial engagement means. Preferably, said support cooperates with a strap hinge which has two parallel hinge straps which receive the support therebetween.

According to a further embodiment, the axial engagement means on the support comprise at least one latching receiver and/or one latching projection oriented perpendicular to the pivoting plane of the lid.

According to a further embodiment, the axial engagement means comprise at least one shoulder on at least one longitudinal side of the strap hinge. The shoulder may be brought into engagement with a latching receiver and/or a latching projection of the support when pivoting the lid.

According to a further embodiment, the axial engagement means comprise at least one edge of the strap hinge on the longitudinal side and at least one latching projection of the support. The latching projection of the support is able to be brought into engagement with the edge of the strap hinge on the longitudinal side.

The lidded container according to the invention for laboratory use comprises

a tubular container which at the bottom has a container base, at the top a container opening and below the container opening a sealing region on the internal wall,

a lid which has a lid base and a plug protruding from the inside of the lid base, and which may be inserted through the container opening into a sealed position in the sealing region,

a strap hinge connecting the two container parts, lid and container, integrally with one another in a pivotable manner and

a holding device for holding the lid in at least one holding position in which the lid is not inserted into the sealed position, the holding device having at least two engagement means, the one engagement means being fixedly connected to the container and the other engagement means being fixedly connected to the lid, the engagement means being radial engagement means which are oriented radially to the pivoting path of the lid, a disc-shaped support protruding to the side of the one container part and which on the edge has at least one radial engagement means, a radial engagement means which may be brought into engagement therewith being a flexible and resilient projection protruding to the side of the other container part and the engagement means being able to be brought into engagement with one another by pivoting the lid into the holding position, which is accompanied by a resilient deviation movement.

In the lidded container according to the invention, the container and lid are pivotably connected together via a strap hinge in the known manner. The strap hinge may comprise one or more hinge straps, which are at least partially flexible. The strap hinge is similar to a film hinge, but may be flexible over a longer region in its longitudinal direction. A strap hinge with at least one hinge strap, which is flexible in the longitudinal direction in at least in one region, simplifies the insertion of the plug in the container opening of a cylindrical container as it permits a compensation movement.

Furthermore, the lidded container comprises a holding device which is able to hold the lid relative to the container in at least one holding position in which the lid does not close the container. In the holding position, the lid is not inserted with the plug into the sealed position in the sealing region. For holding the lid in the holding position the lid and container are fixedly connected to radial engagement means. Said engagement means are oriented radially to the pivoting path of the lid. A disc-shaped support protrudes from the one container part, and which on the edge has at least one radial engagement means. A radial engagement means which may be brought into engagement therewith is a flexible and resilient projection protruding to the side of the other container part. If when pivoting the lid the radial engagement means of the support and the flexible and resilient projection come into contact, a resilient deviation movement permits said engagement means and projection to be moved past one another and to come into engagement with one another in the holding position. The resilient deviation movement may consist, for example, of a resilient deformation of the flexible and resilient projection and/or a deformation of the strap hinge in the pivoting plane. The pivoting of the lid into the holding position takes place independently of the actuation by the user. This is based on the flexibility and resilience of the projection and/or the strap hinge. Thus the projection is guided along the edge of the support. As a result, the pivoting path of the lid is determined in an initial region of the pivoting movement, irrespective of the level, the direction and the point of action of the force which the user exerts on the lid, in order to close said lid. In the lidded container according to the invention, the exertion of force by the user is not affected by considerably increasing the force in order to reach the holding position.

According to one embodiment, the edge of the support is rounded so that when pivoting the lid shut the projection is guided with low friction on the edge of the support.

According to a further embodiment, a plurality of latching receivers are arranged in succession on the edge of the support in the direction of the pivoting path of the lid. This permits the lid to be locked in different selectable holding positions.

The lidded container according to the invention made of plastics material for laboratory use comprises

a tubular container which at the bottom has a container base, at the top a container opening and below the container opening a sealing region on the internal wall,

a lid which has a lid base and a plug protruding from the inside of the lid base, and which may be inserted through the container opening into a sealed position in the sealing region,

a strap hinge connecting the two container parts, lid and container, integrally together in a pivotable manner and

a holding device for holding the lid in a plurality of holding positions in which the lid is not inserted into the sealed position, the holding device having a plurality of engagement means of which the one engagement means is fixedly connected to a container part and the other engagement means is fixedly connected to the other container part, at least the one container part being fixedly connected to a series of the one engagement means arranged in succession in the pivoting direction of the lid and the one engagement means being able to be brought into engagement with the other engagement means into one of several selectable holding positions by pivoting the lid, which is accompanied by a resilient deviation movement.

In the lidded container according to the invention, the container and lid are pivotably connected together via a strap hinge in the known manner. The strap hinge may comprise one or more hinge straps, which are at least partially flexible. The strap hinge is similar to a film hinge but may be flexible over a longer region in its longitudinal direction. A strap hinge with at least one hinge strap, which is flexible in at least one region in the longitudinal direction, simplifies the insertion of the plug in the container opening of a cylindrical container as it permits a compensation movement.

Moreover, the lidded container comprises a holding device which is capable of holding the lid relative to the container in a plurality of holding positions in which the lid does not close the container. In the holding positions, the lid is not inserted with the plug into the sealed position in the sealing region. For holding the lid in different holding positions at least one container part is fixedly connected to a series of the one engagement means arranged in succession in the pivoting direction of the lid. At least one further engagement means is connected to the other container part. If when pivoting the lid the one engagement means and the other engagement means come into contact with one another, a resilient compensation movement permits said engagement means to be moved past one another and to come into engagement with one another in a holding position. The user may pivot the lid shut, sufficiently far until the engagement means come into engagement with one another, and which hold the lid in a desired holding position. Thus the user may obtain different selectable holding positions. In the respective holding positions, the lid may be held by the resilience of the strap hinge which holds the engagement means in engagement with one another.

The lidded container according to the invention made of plastics material for laboratory use comprises

a tubular container which at the bottom has a container base, at the top a container opening and below the container opening a sealing region on the internal wall,

a lid which comprises a lid base and a plug protruding from the inside of the lid base, and which may be inserted through the container opening into a sealed position in the sealing region,

a strap hinge connecting the two container parts (lid and container) integrally together in a pivotable manner and

a holding device for holding the lid in at least one holding position in which the lid is not inserted with the plug into the sealed position, the holding device having at least two engagement means, the one engagement means being fixedly connected to the container and the other engagement means being fixedly connected to the strap hinge or the lid, and the engagement means being able to be brought into positive engagement with one another by pivoting the lid into the holding position, which is accompanied by a resilient deviation movement, whereby the lid is prevented in both pivoting directions from pivoting out of the holding position, which is not accompanied by a resilient deviation movement.

In the lidded container according to the invention, the container and lid are pivotably connected together via a strap hinge in the known manner. The strap hinge may comprise one or more hinge straps which are at least partially flexible. The strap hinge is similar to a film hinge but may be flexible over a longer region in its longitudinal direction. A strap hinge with at least one hinge strap which is flexible in at least one region in the longitudinal direction simplifies the insertion of the plug in the container opening of a cylindrical container as it permits a compensation movement.

Moreover, the lidded container comprises a holding device which is capable of holding the lid relative to the container in a holding position in which the lid does not close the container. In the holding position, therefore, the lid is not inserted with the plug into the sealed position in the sealing region. The holding device holds the lid securely in the holding position as it comprises engagement means which positively engage with one another when the lid is in the holding position.

This positive engagement prevents pivoting of the lid in both pivoting directions, i.e. both in the closing direction and in the opening direction. As a result, the lidded container according to the invention is not dependent on the strap hinge having a permanent resilience which is required to hold the lid in a stop position. In the lidded container according to the invention only a slight resilient deviation movement is required in order to bring the engagement means into positive engagement with one another when pivoting the lid. During this resilient deviation movement, the engagement means move slightly apart from one another in order to be pivoted into an initial position from which they are able to be brought into positive engagement with one another. In this initial position, the engagement means more or less adopt their original shape due to their resilience, whereby the positive engagement is produced. By the positive engagement the lid is thus securely held in the holding position. In contrast to the aforementioned prior art, this does not depend on a high degree of resilience. The required resilience namely does not have to secure the entire lid to a stop and prevent free pivoting away from the stop. The deviation movement may be controlled by the contours of the engagement means coming into contact when pivoting the lid.

It is not possible to release the lid by simply pivoting out of the holding position. Instead, a resilient deviation movement is also required therefor. The contours of the engagement means coming into engagement may be designed so that the lid only leaves the holding position when a specific minimum force is exerted on the lid. As a result, inadvertently departing from the holding position is avoided.

It applies to all lidded containers according to the invention that the holding position may be selected so that the container opening is free for inserting a dispensing tip (for example a pipette tip). Thus the lidded container simplifies the filling and emptying process and contributes to improving working procedures in the laboratory. The lidded container is suitable, in particular, for automatic filling and emptying in a metering station or in a work station for handling liquids. Moreover, the lidded container may be stored in a space-saving manner in the open state, when in the holding position the lid is aligned with the lid base at an angle to the plane through the container opening.

The holding position may be selected so that it holds the lid in any alignment relative to the container and which is not the closed position of the lid. Preferably, in the holding position the lid is at an angle of approximately 45° to 135° from the closed position. In the holding position it is further preferred that the lid is at an angle of approximately 80° to 110° from the closed position. It is further preferred that in the holding position the lid is at an angle of approximately 90° to 100° from the closed position. Preferably, the lid is at an angle of approximately 95° from the closed position, in particular with smaller containers (for example 2.0 ml (0.122 cubic inch) or less). With larger containers (for example larger than 2.0 ml (0.122 cubic inch)) an angle of 90° is preferable.

The following embodiments apply to all inventions described above:

In principle, the strap hinge and/or the engagement means may consist of the basic material of the container and/or the lid. The resilience may be influenced by the design of the strap hinge and/or the engagement means so that it ensures a resilient deviation movement. Moreover, it is possible to use specific materials for the strap hinge and/or the engagement means, which provide a sufficient resilience for the deviation movement.

According to a preferred embodiment, the strap hinge comprises two parallel hinge straps which in each case connect the lid to the container. The two hinge straps are flexible in at least one portion. If the hinge straps are only flexible in one portion, the flexible portions extend over the same distance in the longitudinal direction of the hinge straps. A plurality of parallel hinge straps guide the lid better during pivoting than a single hinge strap in the pivoting plane. They may prevent, in particular, twisting of the lid relative to the container.

According to a further embodiment, the support is disc-shaped with side surfaces extending parallel to the pivoting plane of the lid and has radial engagement means on both side surfaces. According to a preferred embodiment, the radial engagement means comprise latching receivers which are open radially to the pivoting path of the lid and perpendicular to the pivoting plane of the lid. This embodiment of the lidded container with a support promotes the injection-molding of the lidded container using an injection-molding tool without a slide and which may be separated along a single axis for demolding the lidded container.

According to a further embodiment, the edge of the support is rounded. A rounded edge of the support prevents damage to the gloves of a user. To this end, rounded transitions between the engagement means and adjacent structures are also advantageous. Rounded transitions of latching receivers to adjacent regions of the support and/or rounded latching projections and/or rounded latching edges are also advantageous.

The various holding positions permit the user, if required, to fix the lid more or less wide open in a holding position.

According to a further embodiment, the container adjacent to the container opening has an insertion region widening towards the upper edge of the container for the plug and the sealing region thereunder. As a result, the closing of the lidded container is simplified.

According to a further embodiment, the plug is hollow cylindrical. As a result, the plug is particularly flexible, whereby the closing and opening of the lidded container is further simplified.

According to a further embodiment, the plug has a peripheral sealing bead on the external periphery. As a result, the vapor tightness of the lidded container is improved.

According to a further embodiment, the lidded container is produced by injection-molding.

The lidded container according to the invention is produced from one or more plastics materials. According to one embodiment, the lidded container is produced as a whole from resilient plastics material.

According to a further embodiment, the lidded container is produced from one or more polyolefins. Preferably, the lidded container consists of a polypropylene and/or a polyethylene. It is also possible to produce the lidded container with a plug made of different plastics materials which comprise harder and more flexible segments, as disclosed in US 2003/0102323 A1, which is incorporated in the invention by way of reference. The lidded container may be produced, in particular, in a multi-component injection-molding process.

### BRIEF DESCRIPTION OF THE SEVERAL VIEWS OF THE DRAWINGS

The invention is explained in more detail hereinafter with reference to the accompanying drawings of exemplary embodiments. In the drawings:

FIG. 1 shows a lidded container according to the invention in the closed state in a side view;

FIG. 2 shows said lidded container closed in a vertical section;

FIG. 3a+b shows said lidded container in the closed state in a perspective view (FIG. 3a) and an enlarged detail b of FIG. 3a (FIG. 3b);

FIG. 4 shows the lid latch of said lidded container in the closed state in an enlarged vertical partial section;

FIG. 5 shows said lid latch closed in a perspective partial view obliquely from below;

FIG. 6a-c shows said lidded container in the open state in a side view (FIG. 6a), in a plan view (FIG. 6b) and enlarged detail c of FIG. 6b (FIG. 6c);

FIG. 7a+b shows said lidded container in the open state in a perspective view (FIG. 7a) and an enlarged detail b of FIG. 7a (FIG. 7b);

FIG. 8a+b shows said lidded container with the lid locked in an intermediate position in a perspective view (FIG. 8a) and in an enlarged detail b of FIG. 8a (FIG. 8b);

FIG. 9a+b shows said lidded container with the lid locked in the intermediate position in side view (FIG. 9a) and in an enlarged detail b of FIG. 9a (FIG. 9b);

FIG. 10 shows said lid latch at the start of the latching process in an enlarged vertical partial section;

FIG. 11 shows said lid latch before completing the latching process in an enlarged vertical partial section;

FIG. 12 shows said lid latch open in a perspective partial view obliquely from below;

FIG. 13 shows the strap hinge with a further holding device with radial engagement means of the lidded container in the open state in an enlarged perspective view obliquely from above and from the side;

FIG. 14 shows said strap hinge when closing the lidded container in a perspective view; and

FIG. 15 shows the strap hinge with a further holding device with axial engagement means of a lidded container in an enlarged perspective view obliquely from above and from the side.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated

In this application the terms “at the top” and “at the bottom” as well as “upper face” and “lower face” refer to the arrangement of the lidded container in the closed state with a vertically aligned tubular container, the container base being arranged at the bottom and the lid at the top.

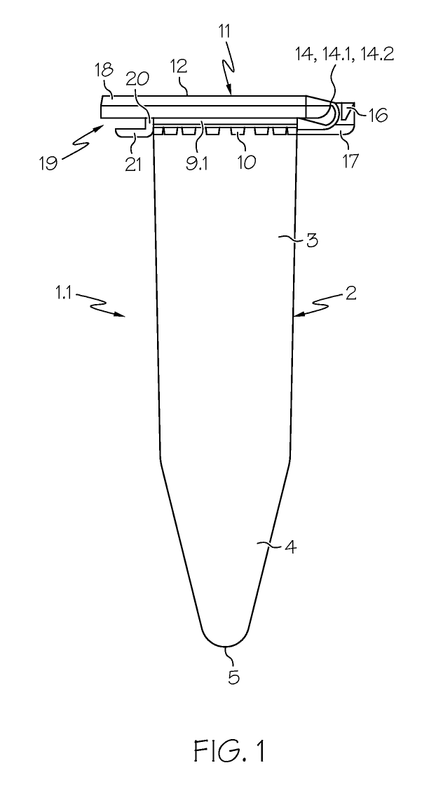

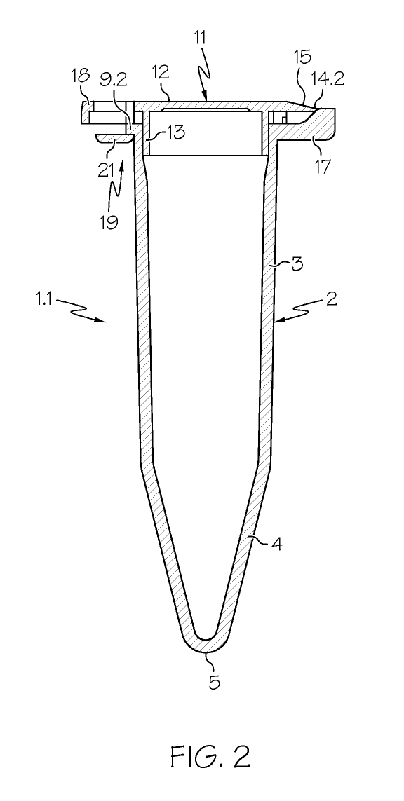

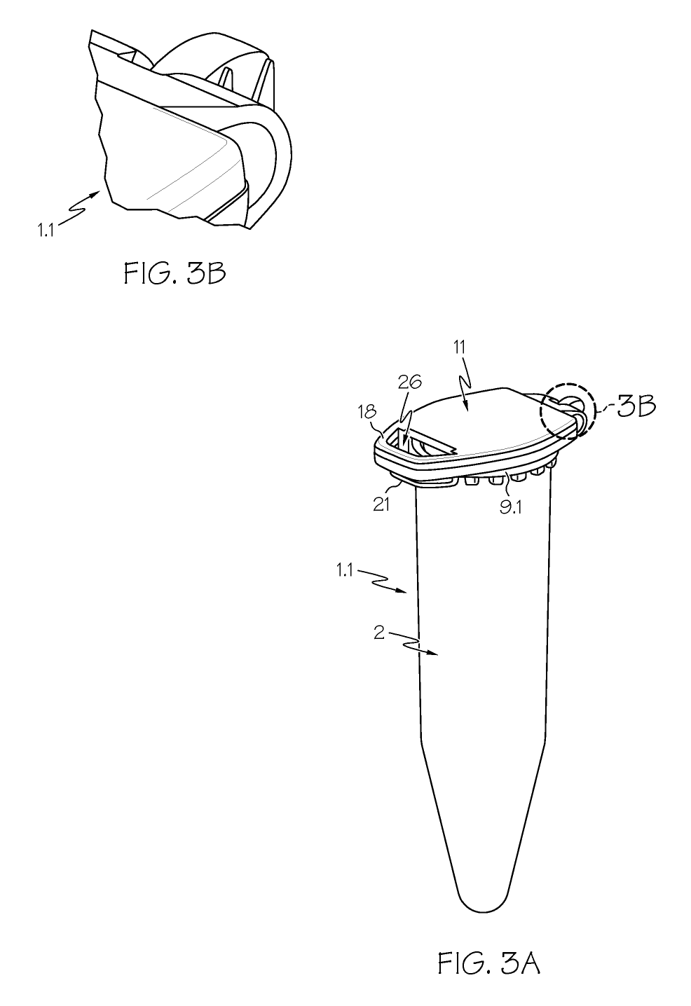

The lidded container 1.1 of FIGS. 1 to 12 comprises a tubular container 2 with a circular cross section, which at the top has a hollow cylindrical portion 3 and at the bottom a conical portion 4. At the very bottom, the container 2 has a cup-shaped base 5. At the top the container 2 has a container opening 6. Thereunder in the hollow cylindrical portion 3 the container has an insertion region 7 tapering conically downwards and a circular cylindrical sealing region 8 thereunder.

At the upper edge, the container 2 has a peripheral flange 9.1, protruding radially outwardly in the form of a circular disc. A latching projection 9.2 is formed on the flange 9.1.

Below the flange 9.1 on the outer periphery of the container 2, a series of tine-like projections 10.1 are optionally arranged, and which serve for supporting on the edge of a container holder.

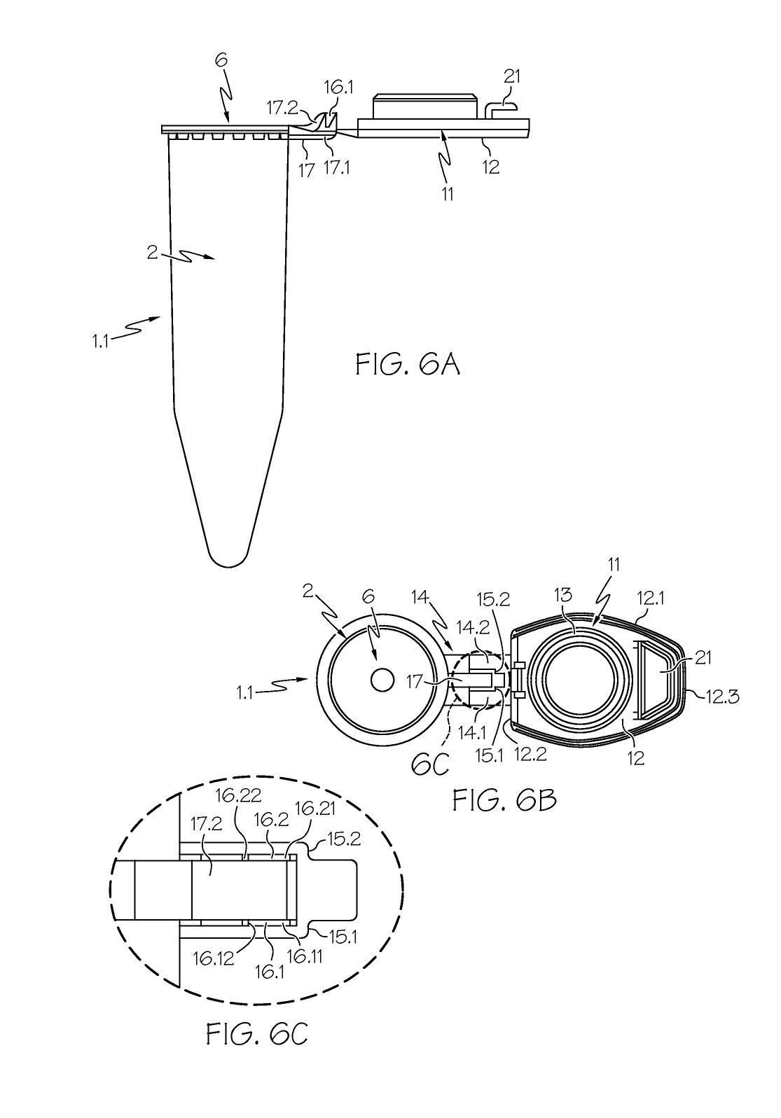

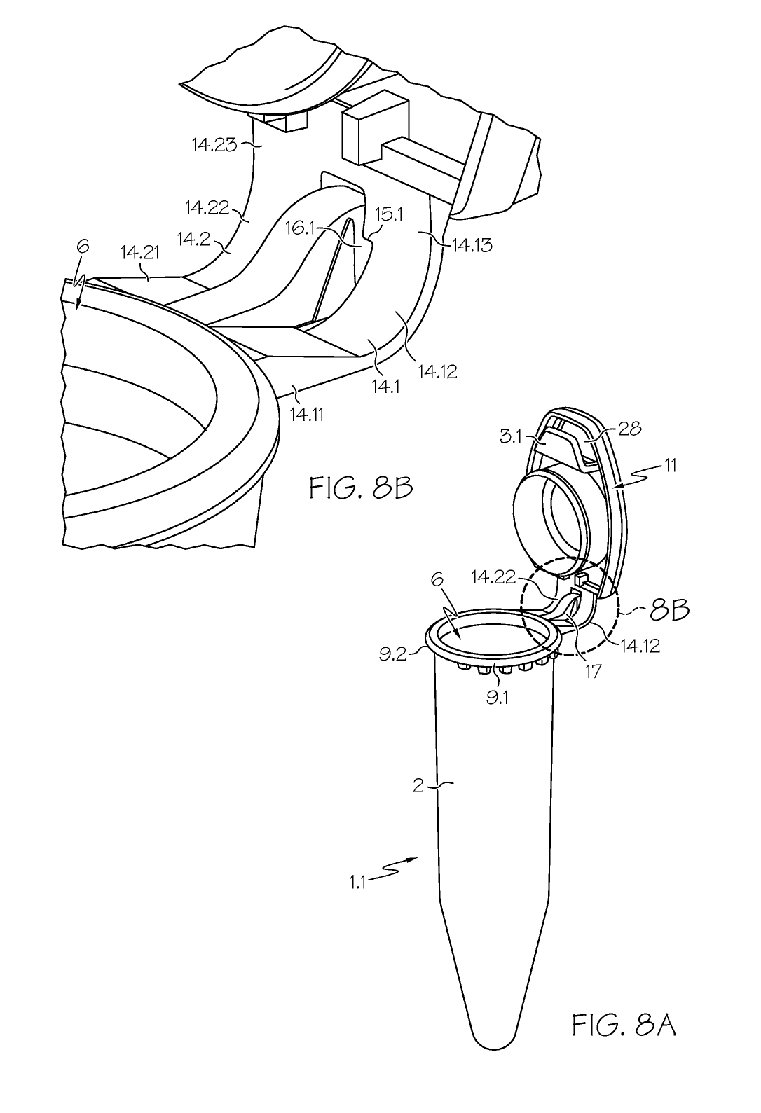

The lidded container 1.1 has a lid 11 which comprises a lid base 12 and a plug 13 protruding downwards from the lid base 12. The plug 13 has a hollow cylindrical plug portion 13.1. At the lower end of the plug portion 13.1 the plug has a peripheral, outwardly protruding sealing bead 13.2. The lid base 12 protrudes as a whole to the side over the plug 13. The lid base 12 has an approximately elliptical contour 12.1. The extent of the lid base 12 in the direction of the main axis of the elliptical contour 12.1 is defined by two approximately straight lid edges 12.2, 12.3 which extend parallel to the auxiliary axis of the elliptical contour 12.1 (FIG. 6b). The outer edge of the lid base 12 is connected via a strap hinge 14 to the upper edge of the container 2. The strap hinge 14 is connected to the longer straight lid edge 12.2. The strap hinge 14 comprises two parallel hinge straps spaced apart from one another 14.1, 14.2 (FIG. 8). The hinge straps 14.1, 14.2 in each case have a more rigid first portion 14.11, 14.21 connected to the upper edge of the container 2 and adjacent thereto in each case a more flexible resilient portion 14.12, 14.22 and adjacent thereto a second more rigid portion 14.13, 14.23 connected to the outer edge of the lid base 12.

Preferably, the hinge straps 14.1, 14.2 are connected integrally to said container parts by injection-molding.

The hinge straps 14.1, 14.2 have on the inside between the flexible portions 14.12, 14.22 and the second more rigid portions 14.13, 14.23 in each case a shoulder 15.1, 15.2 which form axial engagement means (FIG. 6b, c). Between the hinge straps 14.1, 14.2 V-shaped latching receivers 16.1, 16.2 are arranged on both sides of a support 17 protruding to the side of the container 2. The V-shaped latching receivers 16.1, 16.2 in each case are open at the top and to the side of the adjacent hinge straps 14.1, 14.2. They are defined by receiver edges 16.11, 16.12, 16.21, 16.22 oriented radially to the pivoting path of the lid 11 (FIG. 6c, 7b). The latching receivers constitute further axial engagement means.

The support 17 comprises the support part 17.1 which protrudes radially from the edge of the container. The support part 17.1 carries at the top a narrow, disc-shaped or rib-shaped support part 17.2. The disc-shaped support part 17.2 is provided on both flat outer faces 17.3, 17.4 with the latching receivers 16.1, 16.2 (FIG. 6). The upper edge 17.5 of the disc-shaped support part 17.3 is rounded.

Opposite the film hinge 14, the part of the lid base 12 protruding over the plug 13 to the side forms a lid projection 18. The lid projection 18 tapers towards the outer edge of the lid base 12. The lid projection 18 is defined by the shorter straight lid edge 12.3. A latching device 19 is arranged below the lid projection 18. The latching device 19 has a flexible flap 20 which at the top is connected to the lower face of the lid projection 18. The flap 20 comprises two parallel flap strips 20.1, 20.2, which are spaced apart from one another. The flap strips 20.1, 20.2 are connected together at the lower end via a plate-shaped button 21 which protrudes outwardly to the side. In the flap strips 20.1, 20.2 above the button 21 a recess 22 is present. The recess 22 is defined at the bottom by the inner upper edge of the button 21. This edge forms a latching edge 23. The button 21 has a chamfer 24 below said latching edge on the inside and a radius 25 thereunder.

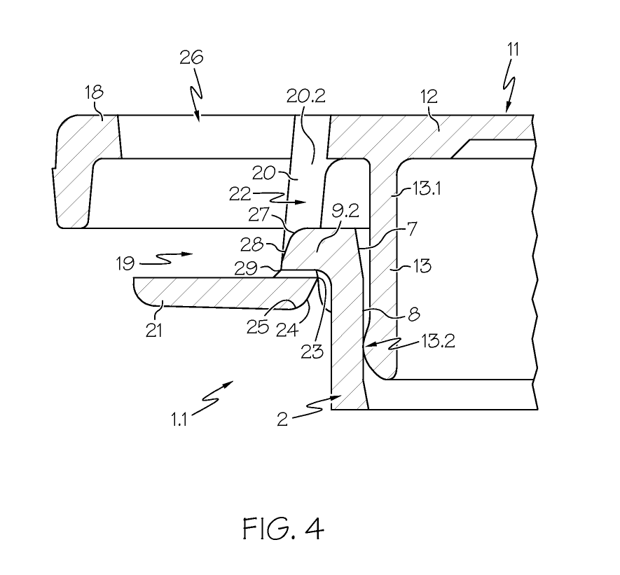

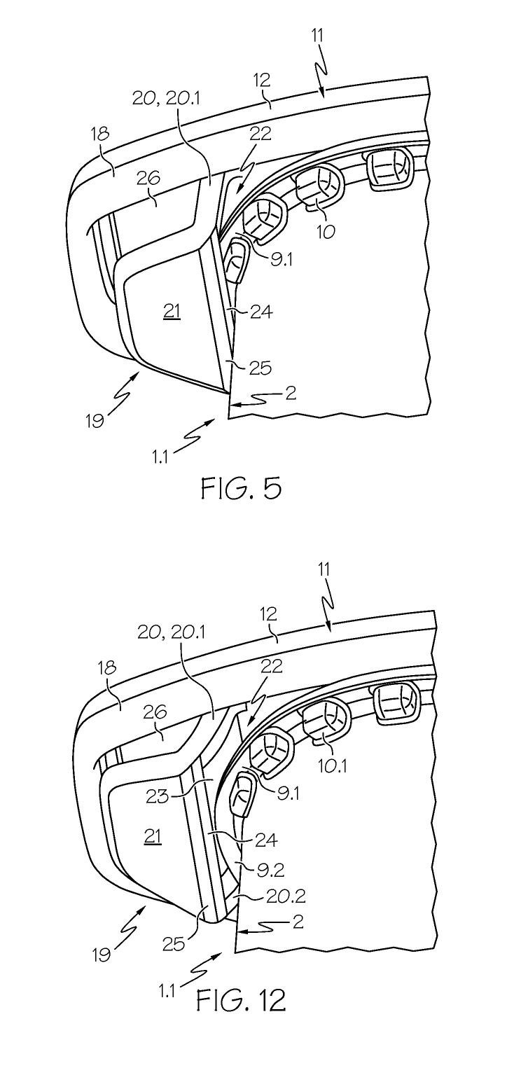

In the non-deflected state, which is shown in FIGS. 4 and 5, the button 21 is arranged below a congruent and/or slightly larger lid recess 26 in the lid projection 18. As a result, an integral production of the entire lidded container 1.1 in one injection-molding process is possible by means of a single tool.

According to FIGS. 4 and 5, the lid 11 in the closed state is latched to the container 2. This is achieved by the latching edge 23 engaging below the flange 9.1 in a region free of tine-like projections 10.1, which forms the latching projection 9.2. The latching projection 9.2 at the top has a radius 27 and thereunder a chamfer 28.

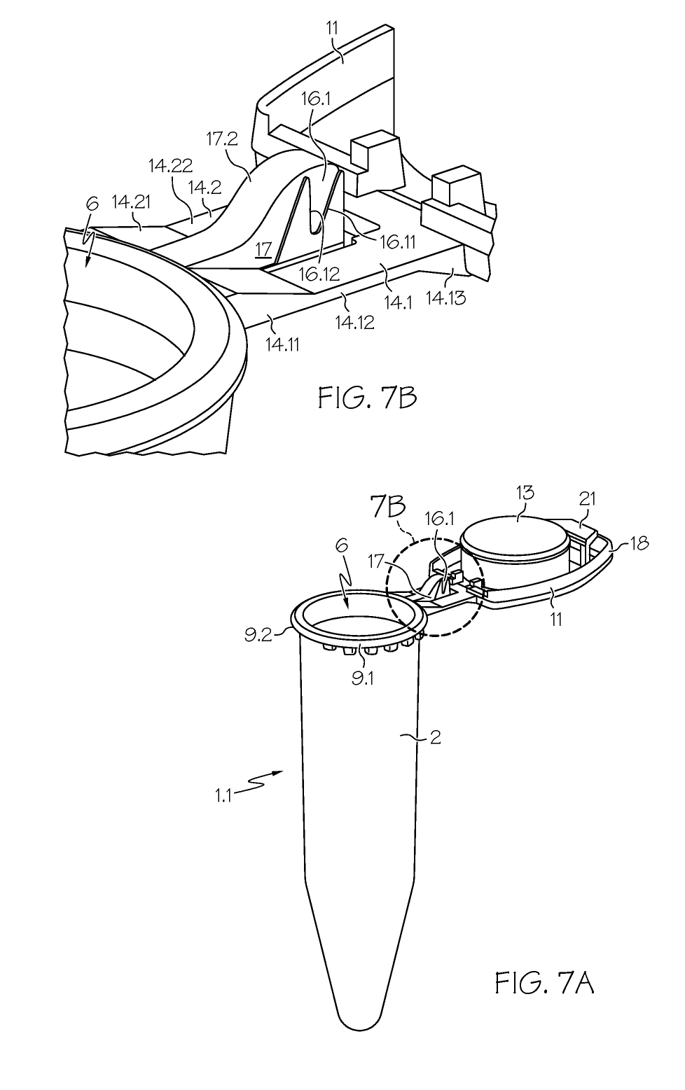

The lidded container 1.1 is produced in the open arrangement shown in FIGS. 6 and 7, by injection-molding. Due to the shape which is free of undercuts, the lidded container 1 may be produced by means of a single injection-molding tool without a slide, the tool parts thereof having to be moved apart only along one axis for demolding.

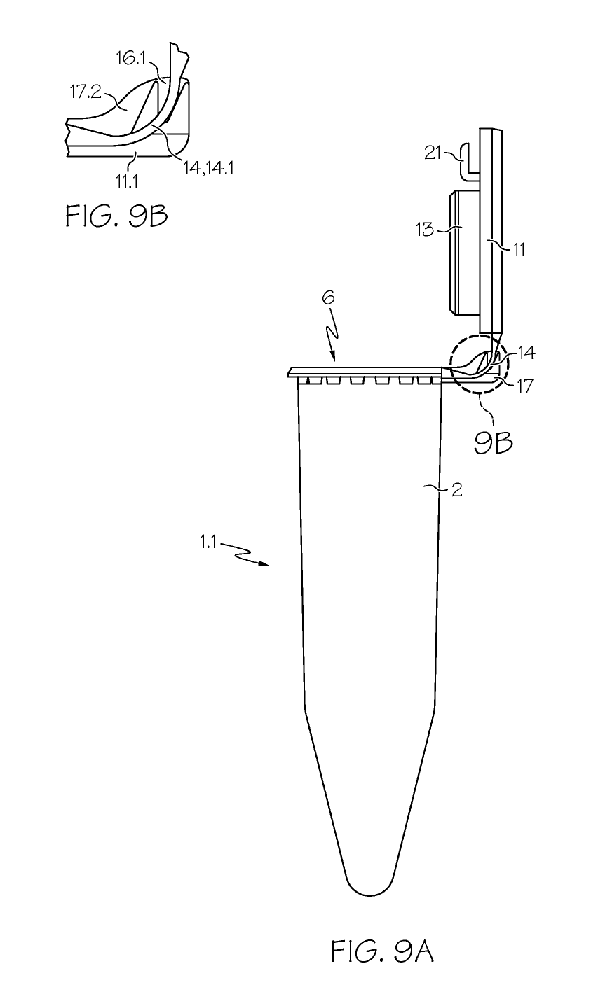

The lid 11 may be closed by being pivoted shut from the open position shown in FIGS. 6 and 7. To this end, the user presses against the outer face of the lid base 12. In an intermediate position according to FIGS. 8 and 9, the lid 11 is able to be locked by wedging the shoulders 15.1, 15.2 in the latching receivers 16.1, 16.2. In this case, the deviation of the shoulders 15.1, 15.2 outwardly to the side and to the rear is permitted by the flexibility of the shoulders 15.1, 15.2 and the strip regions 14.12, 14.22. As soon as the shoulders 15.1, 15.2 enter the region of the latching receivers 16.1, 16.2, due to the resilience of the shoulders 15.1, 15.2 and the strip regions 14.12, 14.22 they enter the latching receivers 16.1, 16.2. In this holding position, the shoulders engage behind the receiver edges 16.11, 16.21 and the lid 11 is held in this holding position by the resilience of the hinge straps 14.1, 14.2.

To close the lid fully, the user presses again against the outer face of the lid base 12. As a result, the lid 11 is pivoted shut out of the holding position. Thus the shoulders 15.1, 15.2 emerge from the openings of the latching receivers 16.1, 16.2, and do not collide with the receiver edges 16.12, 16.22. The receiver edges 16.12, 16.22 may alternatively be arranged so that they are located in the region where the shoulders 15.1, 15.2 pivot shut and the latching receivers 16.1, 16.2 positively receive the shoulders 15.1, 15.2. To this end, the shoulders 15.1, 15.2 have to be forced out of the latching receivers 16.1, 16.2 by utilizing their flexibility, in order to pivot the lid 11 shut.

The latching receivers 16.1, 16.2 are sufficiently rounded that they do not form any sharp edges which may damage the glove of a user.

The upper edge 17.5 of the disc-shaped support part 17.2 is rounded so that the support 17 does not damage the gloves of a user.

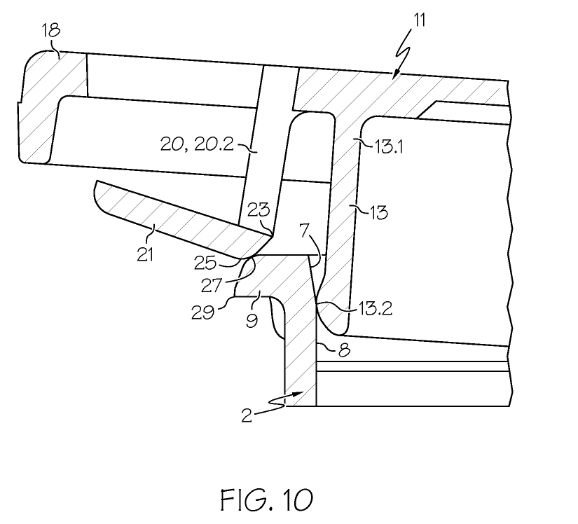

The lid 11 pivots with the plug 13 into the container opening 6, which is facilitated by the widened insertion region 7. Then the sealing bead 13.2 is inserted into the sealing region 8. Thus the button 21 with its radius 25 comes into contact with the radius 27 of the latching projection 9.2, as shown in FIG. 10. When pressing the lid 11 further shut the flap 20 is deflected outwardly to the side. The flexibility of the flap 20 and chamfers 24, 28 of the button 21 and the latching projection 9.2 requires a slightly greater expenditure of force. When the latching edge 23 has reached the latching edge 29 of the latching projection 9.2, the flap 20 springs towards the container 2 and the inner edge of the button 21 engages below the latching projection 9.2 (FIGS. 4, 5). As a result, the latching is complete and the lid 11 secured on the container 2.

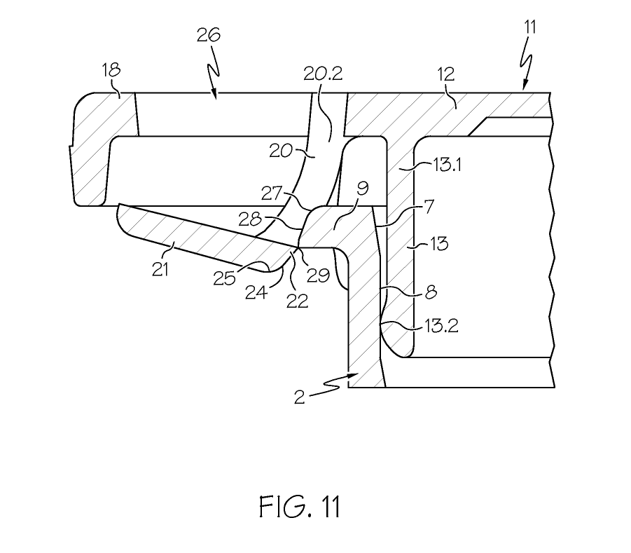

To open the lid 11, the user presses from below against the button 21, so that said button is deflected to the side, as shown in FIGS. 11 and 12. By pressing against the button 21, the lid 11 is moved together with the plug 13 out of the container opening 6 and opened. In the open position the lid 11 may be securely locked, by the shoulders 15.1, 15.2 being engaged in the latching receivers 16.1, 16.2 (FIGS. 8, 9).

In principle, in the lidded container 1.1 disclosed above it is also possible to connect the support 17 rigidly to the edge of the lid 11 and to arrange the shoulders 15.1, 15.2 in the connecting region between the more rigid first portions 14.11, 14.21 and the more flexible resilient portions 14.12, 14.22.

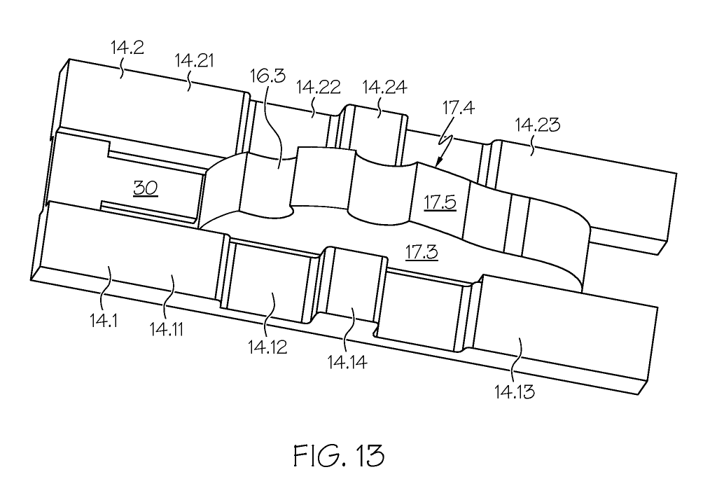

According to FIG. 13, a strap hinge 14 comprises two parallel hinge straps 14.1, 14.2 arranged spaced apart from one another. The hinge straps 14.1, 14.2 in each case have a more rigid first portion 14.11, 14.21 and adjacent thereto in each case a more flexible resilient portion 14.12, 14.22 and adjacent thereto a second more rigid portion 14.13, 14.23. On the resilient portion 14.12, 14.22 in each case is located a material thickening 14.14, 14.24 which controls the specific deformation of said portions.

A disc-shaped support 17 is arranged between the hinge straps 14.1, 14.2 and which in a rounded outer edge 17.5 comprises a series of latching receivers 16.3. The latching receivers 16.3 are also rounded in vertical section.

A resilient latching tongue 30 is arranged between the hinge straps 14.1, 14.2 on one side.

The more rigid first portions 14.11, 14.21 of the hinge straps are connected to the one container part and the ends of the second more rigid portions 14.13, 14.23 to the other container part. Preferably, the first-mentioned ends are connected to a lid 11 and the second-mentioned ends to a container 2. The connection is preferably made in this manner with the edge region of the lid base 12 and the flange 9.1.

Conversely, the ends of the lower more rigid portions 14.11, 14.21 and the latching tongues 30 may be connected to the container 2 and the ends of the second more rigid portions 14.13, 14.23 and the support 17 to the lid 11.

Furthermore, the latching tongue 30 is connected to the one container part and the support 17 to the other container part. Preferably, the latching tongue 30 is connected to the edge of the lid base 12 and the support 17 to the flange 9.1.

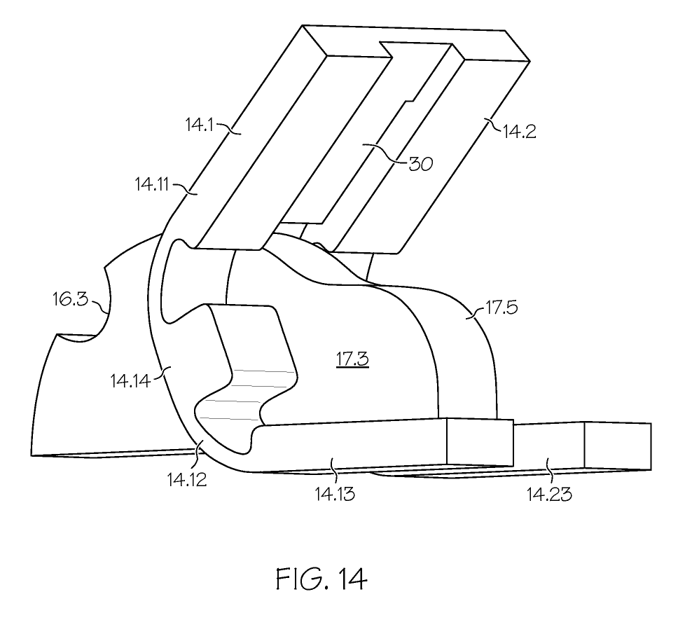

When pivoting up the lid 1 from the position pivoted away from the container opening 6 by 180°, the latching tongue 30 selectively engages in one of the latching receivers 16.3. In this manner, the lid 11 may be securely locked in different holding positions. On the path into the latching receivers 16.3, the latching tongue 30 is guided on the rounded edge 17.5 of the support 17 (FIG. 13). On the path of the lid 11 from the latching receivers 16.3 into the closed position the latching tongue 30 is released from the rounded edge 17.3 (FIG. 14).

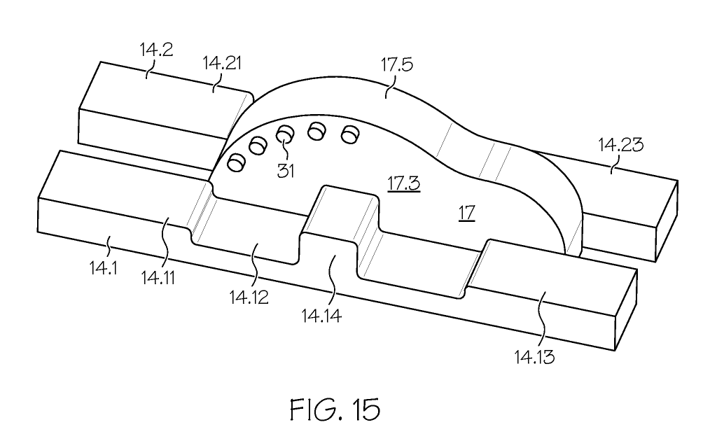

In the exemplary embodiment of FIG. 15, the hinge straps 14.1, 14.2 are described as in the exemplary embodiment of FIG. 13. The support 17 is also connected in a disc-shaped manner to a rounded outer edge 17.3. The support 17 has a series of axial studs 31 on its two side surfaces 17.3, 17.4, in each case in the vicinity of the edge 17.5. The studs 31 form axial engagement means. The studs 31 consist of a resilient plastics material. Instead of the studs 31 other projections of symmetrical or asymmetrical shape may be provided.

The hinge straps 14.1, 14.2 of the exemplary embodiment of FIG. 14 are connected in a similar manner to the hinge straps of the exemplary embodiment of FIG. 13 to a lid 11 and a container 2.

When pivoting the lid 11 relative to the container 2, the lid moves along a pivoting path which is permitted by the hinge straps, the material thickenings 14.14, 14.24 contributing to limiting the pivoting path. The axial studs 31 are arranged perpendicular to the plane through which the pivoting path extends. Furthermore, the studs 31 are arranged parallel to the pivot axis of the lid.

When pivoting the lid, the studs are resiliently compressed on the internal edges of the hinge straps 14.1, 14.2 and/or the hinge straps 14.1, 14.2 deviate outwardly slightly resiliently in the axial direction of the studs 31. The studs 31 emerge on the other side of the hinge straps 14.1, 14.2 and adopt their initial shape. When pivoting the lid 11, therefore, the studs 31 come to bear against the inner edges of the hinge straps 14.1, 14.2 both on the upper and on the lower broad side of the hinge straps 14.1, 14.2. When the studs 31 bear against the internal edges of the lower face and the upper face of the hinge straps 14.1, 14.2, the lid 1 is secured in a holding position. The series of studs 31 permits the lid 11 to be secured relative to the container in various holding positions.

While this invention may be embodied in many different forms, there are described in detail herein a specific preferred embodiment of the invention. This description is an exemplification of the principles of the invention and is not intended to limit the invention to the particular embodiment illustrated

1. A lidded container made of plastics material for laboratory use comprising
a tubular container (2) which at the bottom has a container base (5), at the top a container opening (6) and below the container opening (6) a sealing region (8) on the internal wall,
a lid (11) which has a lid base (12) and a plug (13) protruding from the inside of the lid base, and which may be inserted through the container opening (6) into a sealed position in the sealing region (8),
a strap hinge (14) connecting the two container parts, lid (11) and container (2), integrally together in a pivotable manner and
a holding device for holding the lid (11) in at least one holding position in which the lid (11) is not inserted into the sealed position, the holding device having at least two engagement means (16.1, 16.2, 15.1, 15.2), the one engagement means (16.1, 16.2) being an axial engagement means fixedly connected to the container (2) or lid, and which is oriented perpendicular to the pivoting plane defined by the pivoting path of the lid (11), the other engagement means (15.1, 15.2) being configured on the longitudinal side of the strap hinge and the engagement means (16.1, 16.2, 15.1, 15.2) being able to be brought into engagement with one another by pivoting the lid (11) into the holding position, which is accompanied by a resilient compensation movement.

2. The lidded container of claim 1, wherein a support (17) comprising at least one axial engagement means (16.1, 16.2; 16.3) arranged thereon protrudes to the side from the one container part, and at least one axial engagement means (15.1, 15.2; 30) which may be brought into engagement therewith is formed on a longitudinal side of the strap hinge (14.1, 14.2) adjacent to the support.

3. The lidded container of claim 2, wherein the support (17) is disc-shaped with side surfaces (17.3, 17.4) extending parallel to the pivoting plane of the lid (11) and on both side surfaces comprises axial engagement means (16.1, 16.2).

4. The lidded container of claim 2, wherein the axial engagement means (16.1, 16.2) on the support comprise at least one latching receiver and/or one latching projection oriented perpendicular to the pivoting plane of the lid (11).

5. The lidded container of claim 4, wherein the axial engagement means (15.1, 15.2) comprise at least one shoulder on at least one longitudinal side of the strap hinge (14.1, 14.2).

6. The lidded container of claim 4, wherein the axial engagement means comprise at least one edge of the strap hinge on the longitudinal side and at least one latching projection of the support.

7. A lidded container made of plastics material for laboratory use comprising
a tubular container (2) which at the bottom has a container base (5), at the top a container opening (6) and below the container opening (6) a sealing region (8) on the internal wall,
a lid (11) which has a lid base (12) and a plug (13) protruding from the inside of the lid base, and which may be inserted through the container opening (6) into a sealed position in the sealing region (8),
a strap hinge (14) connecting the two container parts, lid (11) and container (2), integrally together in a pivotable manner and
a holding device for holding the lid (11) in at least one holding position in which the lid (11) is not inserted into the sealed position, the holding device having at least two engagement means (16.1, 16.2, 15.1, 15.2), the one engagement means (16.1, 16.2) being fixedly connected to the container (2) and the other engagement means (15.1, 15.2) being fixedly connected to the lid, the engagement means (16.1, 16.2, 15.1, 15.2) being radial engagement means which are oriented radially to the pivoting path of the lid, a disc-shaped support (17) protruding to the side of the one container part and which on the edge (17.5) has at least one radial engagement means (16.3), a radial engagement means (15.1, 15.2; 30) which may be brought into engagement therewith being configured as a flexible and resilient projection protruding to the side of the other container part and the engagement means (16.1, 16.2, 15.1, 15.2) being able to be brought into engagement with one another by pivoting the lid (11) into the holding position, which is accompanied by a resilient compensation movement.

8. The lidded container of claim 7, wherein the radial engagement means (16.3) on the support (17) is a latching receiver extending from the edge (17.5) of the support (17) radially to the pivoting path of the lid into the support (17).

9. The lidded container of claim 7, wherein the edge (17.5) of the support (17) is rounded.

10. The lidded container of claim 8, wherein a plurality of latching receivers are arranged in succession on the edge (17.5), in the direction of the pivoting path.

11. The lidded container of claim 7, wherein the edge (17.5) of the support (17) is rounded.

12. A lidded container made of plastics material for laboratory use comprising
a tubular container (2) which at the bottom has a container base (5), at the top a container opening (6) and below the container opening (6) a sealing region (8) on the internal wall,
a lid (11) which has a lid base (12) and a plug (13) protruding from the inside of the lid base, and which may be inserted through the container opening (6) into a sealed position in the sealing region (8),
a strap hinge (14) connecting the two container parts, lid (11) and container (2), integrally together in a pivotable manner and
a holding device for holding the lid (11) in a plurality of holding positions in which the lid (11) is not inserted into the sealed position, the holding device having a plurality of engagement means (16.1, 16.2, 15.1, 15.2) of which the one engagement means (16.1, 16.2) are fixedly connected to the one container part (2) and the other engagement means (15.1, 15.2) are fixedly connected to the other container part (11) or the strap hinge, at least the one container part being fixedly connected to a series of the one engagement means arranged in succession in the pivoting direction of the lid and the one engagement means being able to be brought into engagement with the other engagement means (16.1, 16.2, 15.1, 15.2) into one of several selectable holding positions by pivoting the lid (11), which is accompanied by a resilient deviation movement.

13. A lidded container made of plastics material for laboratory use comprising
a tubular container (2) which at the bottom has a container base (5), at the top a container opening (6) and below the container opening (6) a sealing region (8) on the internal wall,
a lid (11) which has a lid base (12) and a plug (13) protruding from the inside of the lid base, and which may be inserted through the container opening (6) into a sealed position in the sealing region (8),
a strap hinge (14) connecting the two container parts, lid (11) and container (2), integrally together in a pivotable manner and
a holding device for holding the lid (11) in at least one holding position in which the lid (11) is not inserted into the sealed position, the holding device having at least two engagement means (16.1, 16.2, 15.1, 15.2), the one engagement means (16.1, 16.2) being fixedly connected to the container (2) and the other engagement means (15.1, 15.2) being fixedly connected to the lid (11), and the engagement means (16.1, 16.2, 15.1, 15.2) being able to be brought into positive engagement with one another by pivoting the lid (11) into the holding position, which is accompanied by a resilient deviation movement, whereby the lid (11) is prevented in both pivoting directions from pivoting out of the holding position, which is not accompanied by a resilient deviation movement.

14. The lidded container of claim 1, wherein the strap hinge (14) and/or the engagement means (16.1, 16.2, 15.1, 15.2; 16.3, 30; 14.1, 14.2, 31) are at least partially resilient, in order to perform the resilient deviation movement when pivoting the lid (11) into the holding position.

15. The lidded container of claim 1, wherein the strap hinge (14) comprises two parallel hinge straps (14.1, 14.2) which in each case connect the lid (11) to the container (2).

16. The lidded container of claim 1, wherein the hinge straps (14.1, 14.2) comprise axial engagement means on the inner edges of their broad sides.

17. The lidded container of claim 7, wherein the flexible and resilient projection is arranged between the two hinge straps (14.1, 14.2).

18. The lidded container of claim 1, which is produced from at least one polyolefin.

19. The lidded container of claim 1, which is injection-molded.
